(19) United States
(12) Patent Application Publication
(10) Pub. No.: US 2009/0157747 A1
(43) Pub. Date: Jun. 18, 2009

(54) Administering A Digital Media File Having One Or More Potentially Offensive Portions

(75) Inventors: James G. McLean, Fuquay-Varina, NC (US); Daniel J. Winarski, Tucson, AZ (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/956,242

(22) Filed: Dec. 13, 2007

(51) Int. Cl. G06F 7/00

(52) U.S. Cl. 707/104.1; 707/E17.044; 707/E17.019

(57) ABSTRACT

Methods, digital media files, apparatus, and products for administering a digital media file having one or more potentially offensive portions are described that include inserting in the digital media file at least one tag identifying as potentially offensive a portion of the digital media file, the tag also identifying a location of the potentially offensive portion in the digital media file; and transmitting the digital media file with the tag to a playback device.

### BACKGROUND OF THE INVENTION

1. Field of the Invention

The field of the invention is data processing, or, more specifically, methods, digital media files, apparatus, and products for administering a digital media file having one or more potentially offensive portions.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computer systems today are used for many and varying tasks such as digital media distribution. Current digital media, such as audio, visual, or textual content may include content that is considered unsuitable by some users. As storage and usage of such digital media moves toward centralized servers with selection of the digital media content available on-demand or through random access, greater control of potentially offensive digital media content is needed. Current techniques for controlling such potentially offensive digital media lack fine grained access controls that can be administered across many differing computing platforms, operating systems, and hardware devices.

### SUMMARY OF THE INVENTION

Methods, digital media files, apparatus, and products for administering a digital media file having one or more potentially offensive portions are described that include inserting in the digital media file at least one tag identifying as potentially offensive a portion of the digital media file, the tag also identifying a location of the potentially offensive portion in the digital media file; and transmitting the digital media file with the tag to a playback device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system capable of administering a digital media file having one or more potentially offensive portions according to embodiments of the present invention.

FIG. 2 sets forth a flow chart illustrating an exemplary method for administering a digital media file having one or more potentially offensive portions according to embodiments of the present invention.

FIG. 3 sets forth a flow chart illustrating an exemplary method for administering a digital media file having one or more potentially offensive portions according to embodiments of the present invention.

FIGS. 4A and 4B set forth a block diagram illustrating exemplary digital media files useful in administering a digital media file having one or more potentially offensive portions according to embodiments of the present invention.

### DETAILED DESCRIPTION OF EXEMPLARY EMBODIMENTS

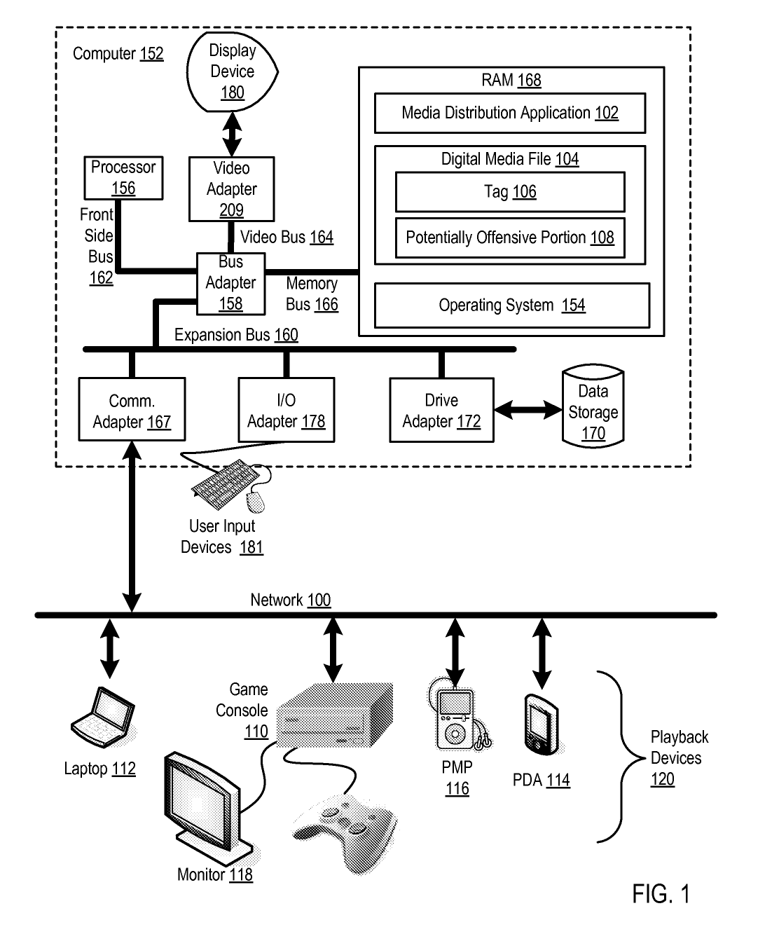

Exemplary methods, digital media files, apparatus, and products for administering a digital media file having one or more potentially offensive portions in accordance with the present invention are described with reference to the accompanying drawings, beginning with FIG. 1. FIG. 1 sets forth a functional block diagram of an exemplary system capable of administering a digital media file having one or more potentially offensive portions according to embodiments of the present invention. The system of FIG. 1 includes several computing devices (152, 112, 118, 110, 116, 114), connected by a data communications network (100), useful in administering digital media files that include one or more potentially offensive portions in accordance with embodiments of the present invention.

“Potentially offensive” as the term is used in this specification may be used to describe any content of which a user may wish to control the playback. That is, multi-media content that may be undesirable to a recipient of the content. Offensive content may include, for example, graphic violence, sexual situations, curse words, and the like. Offensive content may also include, for example, time-sensitive content that is to be displayed only at a particular time, only by particular playback devices, for particular recipients, or the like. A user may, for example, prefer a blue background color to a white background color during the playback of a particular content. In such a case, the background color is a potentially offensive portion of the content.

A digital media file, as the term is used in this specification, is an aggregation of digital media data cognizable as a file by a computer operating system. A digital media file can be implemented in a wide variety of file formats, including, for example, audio files, video files, graphics files such as JPEG files, web pages such as HTML files or XML files, computer-aided design (‘CAD’) files, video game files, and so on. Digital media files are ‘played’ or ‘played back’ by a playback device. Digital media files are transmitted to playback devices from a digital media provider.

A ‘digital media provider’, as the term is used in this specification, is automated computing machinery, one or more computers, that provides the service of distributing or downloading on request digital media files from the provider to a playback device. In the example of FIG. 1, the digital media provider is represented as a computer (152) connected to playback devices (120) through the network (100). Many forms of a computer can serve as a digital media provider, however, including, for example, personal computers, web servers, mainframe computers, and so on.

The exemplary computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152). Stored in RAM (168) of the exemplary computer (152) of FIG. 1 is a media distribution application (102). The media distribution application (102) is a module of computer program instructions capable of administering a digital media file (104) having one or more potentially offensive portions (108) according to embodiments of the present invention. The media distribution application (102) operates generally for administering a digital media file having one or more potentially offensive portions according to embodiments of the present invention by: inserting in the digital media file (104) at least one tag (106) identifying as potentially offensive a portion (108) of the digital media file (104), the tag also identifying a location of the potentially offensive portion in the digital media file and transmitting the digital media file (104) with the tag (106) to a playback device (120).

A ‘tag’ as the term is used in this specification represents an identification of a portion of a digital media file as potentially offensive. A tag may identify a location of the potentially offensive portion of the digital media file with a pointer identifying the beginning of the portion and a size of the portion. A tag may also identify a location of the potentially offensive portion of the digital media file by including a header in the digital media located before the portion and a footer located after the portion. In such cases, the header identifies the beginning of the potentially offensive portion while the footer identifies the end of the potentially offensive portion of the digital media file.

A tag may also include one or more attributes describing the potentially offensive material in the digital media file. Attributes may include an identification of a type of potentially offensive material, an identification of a sub-type of potentially offensive materially, an identification of severity of potentially offensive material. Consider Table 1, below, as an example of attributes describing potentially offensive material in a digital media file.

TABLE 1
Attributes Describing Potentially Offensive
Material In A Digital Media File

| | |
|---|---|
| Type | Violence |
| Sub-type | Physical Conflict |
| Sub-type | Weapons Use |
| Severity | Moderate |

Table 1 above includes exemplary attributes describing potentially offensive material in a digital media file. Table 1 above includes an identification of a type of the potentially offensive material as “Violence.” That is, the potentially offensive material may contain representations of violence. Other possible types of potentially offensive material may include strong language, sexual content, drug use, and so on as will occur to those of skill in the art.

Table 1 above also includes two identifications of sub-types of the potentially offensive material in the digital media file. One sub-type is identified as “Physical Conflict” connoting violence that is of a physical nature in contrast to violence of a verbal nature. Another sub-type included in Table 1 above identifies the potentially offensive material as material representing “Weapons Use.”

Table 1 above also includes an identification of severity of the potentially offensive material in the digital media file. The severity of the potentially offensive material is identified as “Moderate.” The combination of the type, two sub-types, and the severity identified in exemplary Table 1 above, therefore, describes the potentially offensive material in the digital media file as moderately violent material representing a physical conflict that includes weapons use. Although exemplary Table 1 includes identifications implemented as written descriptions, readers of skill in the art will recognize that such identifications may be implemented as other values, such as numbers or codes that may simplify processing of such attributes. For example, an identification of severity may include a value 1, 2, or 3, where a 1 represents a mild severity, a 2 represents a moderate severity, and 3 represents an extreme severity. One type, two sub-types, and an identification of severity is shown in Table 1 for clarity only, not for limitation. Tags in accordance with embodiments of the present invention may include more or less attributes as will occur those of skill in the art.

Digital media files having tags in accordance with embodiments of the present invention may be transmitted from a digital media provider, such as the computer (152) in FIG. 1, to a playback device in various ways, including for example, by downloading to the playback device the entire digital media file or by streaming the digital media file to the playback device in a digital media stream. A digital media stream is multimedia content that is delivered to a media playback device during playback. A digital media stream may be a VOIP stream or an IPTV stream. VOIP stands for ‘Voice Over Internet Protocol,’ a generic term for routing speech over an IP-based data communications network. The speech data flows over a general-purpose packet-switched data communications network, instead of traditional dedicated, circuit-switched voice transmission lines. Protocols used to carry voice signals over the IP data communications network are commonly referred to as ‘Voice over IP’ or ‘VOIP’ protocols. VOIP traffic may be deployed on any IP data communications network, including data communications networks lacking a connection to the rest of the Internet, for instance on a private building-wide local area data communications network or ‘LAN.’

Many protocols are used to effect VOIP. The two most popular types of VOIP are effected with the IETF's Session Initiation Protocol (‘SIP’) and the ITU's protocol known as ‘H.323.’ SIP clients use TCP and UDP port 5060 to connect to SIP servers. SIP itself is used to set up and tear down calls for speech transmission. VOIP with SIP then uses Real-time Transport Protocol (‘RTP’) for transmitting the actual encoded speech. Similarly, H.323 is an umbrella recommendation from the standards branch of the International Telecommunications Union that defines protocols to provide audio-visual communication sessions on any packet data communications network.

IPTV stands for ‘Internet Protocol Television,’ a generic term for routing digital television content over an IP-based data communications network. The digital television content flows over a general-purpose, packet-switched data communications network, instead of traditional television cables, satellite transmission technology, or terrestrial antennas. IPTV traffic may be deployed on any IP data communications network, including data communications networks lacking a connection to the rest of the Internet, for instance on a private building-wide local area data communications network or ‘LAN.’

IPTV content is typically compressed using either a MPEG-2 or a MPEG-4 codec and then sent in an MPEG transport stream delivered via IP Multicast. IP Multicast is a method in which information can be sent to multiple media playback devices at the same time. IPTV may be effected by using Internet Group Management Protocol (‘IGMP’) to connect to a multicast stream, a digital television channel, and to change from one multicast stream to another. IGMP is the communications protocol used to manage the membership of Internet Protocol multicast groups. IGMP is used by IP hosts and adjacent multicast routers to establish multicast group memberships.

The system of FIG. 1 also includes several playback devices (120). A playback device is any automated computing machinery capable of playing a digital media file in accordance with embodiments of the present invention. Examples of playback devices in the system of FIG. 1 include a laptop (112), a game console (110) connected to a monitor (118), a portable media player (‘PMP’) (116), and a personal digital assistant (‘PDA’) (114). The playback devices in the system of FIG. 1 are useful in administering a digital media file having one or more potentially offensive portions in accordance with the present invention. Each of the exemplary playback devices in the example of FIG. 1 includes hardware, software, firmware or some combination therefore that operates generally for administering a digital media file having one or more potentially offensive portions in accordance with the present invention by: receiving, in the playback device, the digital media file with the tag; identifying an action to take in dependence upon the tag and one or more potentially offensive material settings; and playing the digital media file including taking the identified action.

Potentially offensive material settings are rules specifying actions to take in dependence upon a tag in a digital media file. The potentially offensive material settings may be device specific or user specific. In some instances, for example, a playback device may have many users. If potentially offensive material settings are device specific, each user of the playback device will be subject to the actions specified in the potentially offensive material settings. If the potentially offensive material settings are user specific, in contrast, each user of the playback device may have separate and distinct actions specified in that user's potentially offensive material settings. In some embodiments, user specific potentially offensive material settings may be stored in a user profile. User profiles may be stored in computer memory of the playback device or in a location that is remote with respect to the playback device such as, for example, a file server connected to the playback device through a data communications network.

Potentially offensive material settings may be as broad or narrow as the scope of the tag in the digital media file. If a tag includes many different attributes describing the potentially offensive material in the digital media file, for example, potentially offensive material settings may specify distinct actions to take in accordance with each of the attributes separately or actions to take in accordance with combinations of the attributes. Consider as an example of such potentially offensive material settings, Table 2 below.

TABLE 2
Potentially Offensive Materials Settings

| Type | Sub-type | Sub-type | Severity | Action |
|---|---|---|---|---|
| Violence | Physical | Weapons | Moderate | Replace Portion |
| | Conflict | Use | | |
| Violence | Verbal | | Mild | Play Original Portion |
| | Conflict | | | |
| Violence | Sexual | Drug Use | Extreme | Do Not Play Portion |
| | Content | | | |

Table 2 includes potentially offensive material settings for three different combinations of attributes describing potentially offensive portion of a digital media file. The first combination specifies an action for potentially offensive portions of a violent type, having physical conflict, weapons use, and a moderate severity. The action identified for such potentially offensive portions includes replacing the portion during playback of the digital media with a replacement portion. The second combination specifies an action for potentially offensive portions of a violent type, having verbal conflict, and a severity of mild. The action identified for such potentially offensive portions includes playing the original, un-edited potentially offensive portion. The third combination specifies an action for potentially offensive portions of a violent type that include sexual content, drug use, and have an extreme severity rating. The action identified for such potentially offensive portions includes not playing the potentially offensive portion. Table 2 above is only an example of a possible set of potentially offensive material settings described for clarity, not for limitation. Readers of skill in the art will recognize that potentially offensive material settings in accordance with embodiments in the present invention may be narrower or broader. Potentially offensive material settings may also include, for example, identifications of alternative actions. Alternative actions may be included for cases in which the first identified action is to replace the potentially offensive portion, but no replacement portions are provided with the digital media file. An alternative action in such a case may specify an action of playing the original portion, not playing any portion, or prompting the user for a selection.

In addition to the media distribution application (102), also stored in RAM (168) of the exemplary computer (152) of FIG. 1 is an operating system (154). Operating systems useful for administering a digital media file having one or more potentially offensive portions according to embodiments of the present invention include UNIX™, Linux™, Microsoft XP™, Microsoft Vista™, AIX™, IBM's i₅/OS™, and others as will occur to those of skill in the art. The operating system (154) and the network management module (122), in the example of FIG. 1 are shown in RAM (168), but many components of such software typically are stored in non-volatile memory also, such as, for example, on a disk drive (170).

The exemplary computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for administering a digital media file having one or more potentially offensive portions according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory) (134), RAM drives, and so on, as will occur to those of skill in the art.

The exemplary computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) that couples the computer for data communications with other servers in the data center through a data communications network (100). Such a data communication network (100) may be implemented with external buses such as a Universal Serial Bus (‘USB’), or as an Internet Protocol (‘IP’) network or an Ethernet™ network, an I²C network, a System Management Bus (‘SMBus’), an Intelligent Platform Management Bus (‘IPMB’), for example, and in other ways as will occur to those of skill in the art. Communications adapters implement the hardware level of data communications through which one computer sends data communications to another computer, directly or through a data communications network. Examples of communications adapters useful for administering a digital media file having one or more potentially offensive portions according to embodiments of the present invention include modems for wired dial-up communications, Ethernet (IEEE 802.3) adapters for wired data communications network communications and 802.11 adapters for wireless data communications network communications.

The arrangement of computers, network, and playback devices making up the exemplary system illustrated in FIG. 1 are for explanation, not for limitation. Data processing systems useful according to various embodiments of the present invention may include additional playback devices, computers, servers, routers, and other devices, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), RTP (Real-time Transport Protocol), and RTCP (Real-time Control Protocol), and others as will occur to those of skill in the art. Various embodiments of the present invention may be implemented on a variety of hardware platforms in addition to those illustrated in FIG. 1.

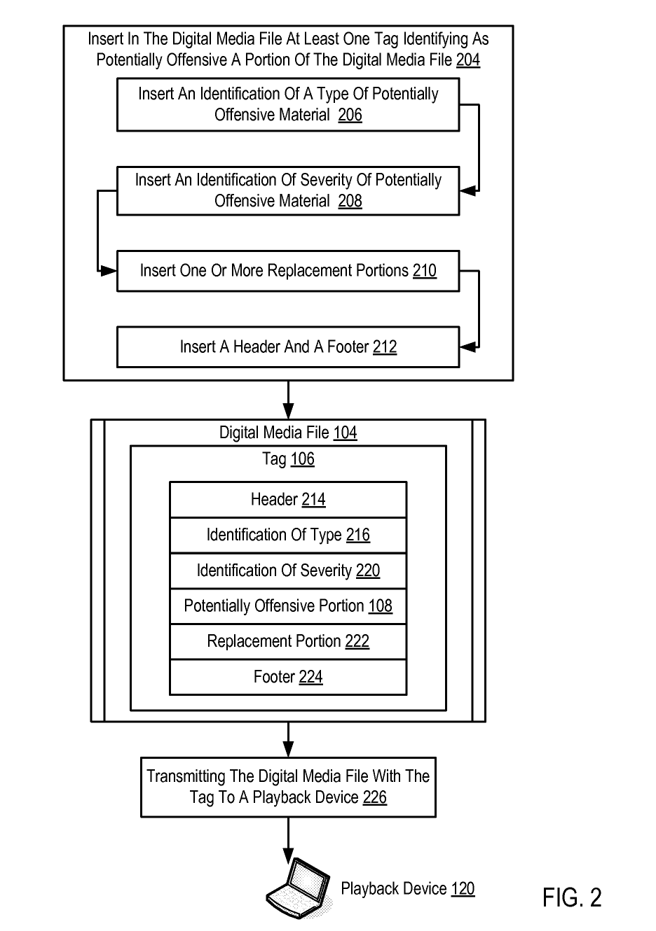

For further explanation, FIG. 2 sets forth a flow chart illustrating an exemplary method for administering a digital media file having one or more potentially offensive portions according to embodiments of the present invention. The method of FIG. 2 includes inserting (204) in the digital media file (104) at least one tag (106) identifying as potentially offensive a portion (108) of the digital media file (104), the tag (106) also identifying a location of the potentially offensive portion in the digital media file (104). Inserting (204) in the digital media file (104) at least one tag (106) identifying as potentially offensive a portion (108) of the digital media file (104) may be carried out by inserting a pointer in the digital media file. The pointer may specify the starting point of a portion of the digital media file as well as a size of the portion, thereby identifying the location of the potentially offensive portion. Inserting (204) in the digital media file (104) at least one tag (106) identifying as potentially offensive a portion (108) of the digital media file (104) may also be carried out by inserting (212) as part of the tag a header (214) and a footer (224), the header (214) inserted before the potentially offensive portion (108) of the digital media file (104), the footer (224) inserted after the potentially offensive portion (108) of the digital media file (104). The header may identify the starting point of the potentially offensive portion and the footer may identify the end of the potentially offensive portion.

In the method of FIG. 1, inserting (204) in the digital media file (104) at least one tag (106) identifying as potentially offensive a portion (108) of the digital media file (104) also includes inserting (206) as part of the tag (106) an identification (216) of a type of potentially offensive material; inserting (208) as part of the tag (106) an identification (220) of severity of potentially offensive material; and inserting (210) as part of the tag one or more replacement portions (222) for replacing the potentially offensive portion (108) of the digital media file (104) upon playback of the digital media file.

A replacement portion (222) for replacing the potentially offensive portion (108) of the digital media file (104) upon playback of the digital media file is digital media content that can be used by a playback device to replace a portion of a digital media file. A replacement portion may be included as part of the digital media file or store remotely with respect to a playback device. A replacement portion may also include a replacement type. A replacement type identifies the type of the portion that may be used in replacing a potentially offensive material. Replacement types may identify a replacement portion as having a lower severity, a different type, or a different subtype than that of the original, potentially offensive portion of the digital media file. Example replacement types may include “non-violent,” “violent, no verbal conflict only,” “violent, physical conflict, no weapons use” and so on as will occur to those of skill in the art. Rules specified in potentially offensive material settings may identify, in addition to the action of replacing the potentially offensive portion of the digital media file, particular replacement types to be selected when carrying out the action of replacing the potentially offensive portion. Some users may specify that only a replacement portion having a lower severity be used to replace the potentially offensive portion of the digital media file while other users may identify that only a replacement portion of a particular type or sub-type be used in replacing the potentially offensive portion of the digital media file.

The method of FIG. 1 also includes transmitting (226) the digital media file (104) with the tag (106) to a playback device (120). Transmitting (226) the digital media file (104) to a playback device (120) may be carried out in various ways including, for example, streaming the digital media file to a playback device over a data communications network, downloading from a server to a playback device the digital media file in its entirety over a data communications network, emailing the digital media file to a playback device, and in other ways as will occur to those of skill in the art.

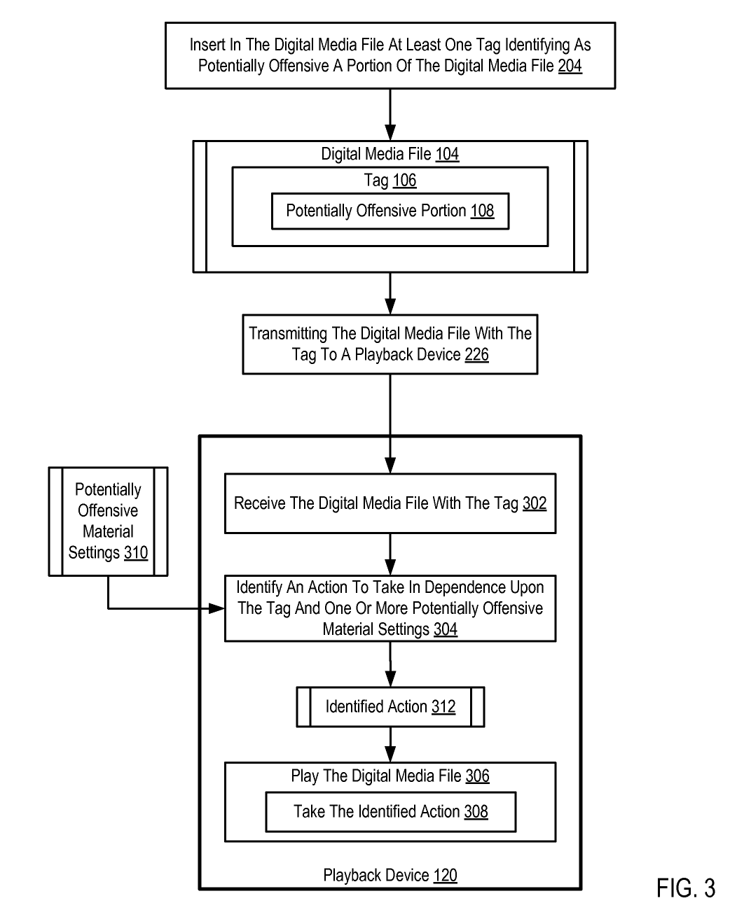

For further explanation, FIG. 3 sets forth a flow chart illustrating an exemplary method for administering a digital media file having one or more potentially offensive portions according to embodiments of the present invention. The method of FIG. 3 is similar to the method of FIG. 2 in that the method of FIG. 3 includes inserting (204) in the digital media file (104) at least one tag (106) identifying as potentially offensive a portion (108) of the digital media file (104) and transmitting (226) the digital media file (104) with the tag (106) to a playback device (120). The method of FIG. 3 differs from the method of FIG. 2, however, in that the method of FIG. 3 also includes receiving (302), in the playback device (120), the digital media file (104) with the tag (106); identifying (304) an action (312) to take in dependence upon the tag and one or more potentially offensive material settings (310); and playing (306) the digital media file (306) including taking (308) the identified action (312).

Receiving (302), in the playback device (120), the digital media file (104) with the tag (106) may be carried out by receiving the digital media file by download through a data communications network, as a digital media stream in a web browser through a data communications, as an attachment to an email, or in other ways as will occur those of skill in the art. The digital media file may, for example, be streamed in accordance with VOIP or IPTV protocols.

Identifying (304) an action (312) to take in dependence upon the tag and one or more potentially offensive material settings (310) may be carried out by identifying any attributes specified in the tag and determining actions identified in the potentially offensive material settings for material having such attributes. That is, a playback device may identify actions associated with attributes matching the attributes specified in the tag of the digital media file.

Playing (306) the digital media file (306) including taking (308) the identified action (312) may be carried out by not playing the potentially offensive portion of the digital media file identified by the tag. That is, the identified action may specify that the potentially offensive portion should not be played during playback. Playing (306) the digital media file (306) including taking (308) the identified action (312) may also be carried out by playing a replacement portion of the digital media file included in the tag in place of the potentially offensive portion of the digital media file. That is, the identified action may specify that a particular replacement portion be played in place of the potentially offensive portion of the digital media file. Playing (306) the digital media file (306) including taking (308) the identified action (312) may also be carried out by playing the potentially offensive portion of the digital media file. That is, in some cases, the identified action may specify that the potentially offensive portion should be played during playback, in its entirety, un-edited.

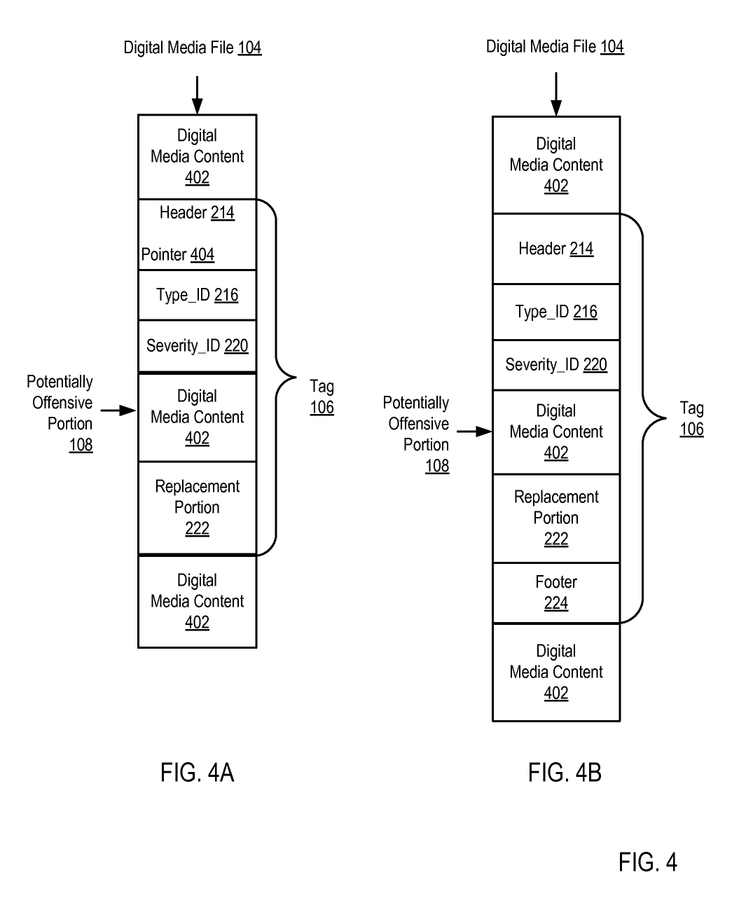

For further explanation, FIGS. 4A and 4B set forth a block diagram illustrating exemplary digital media files useful in administering a digital media file having one or more potentially offensive portions according to embodiments of the present invention. The digital media file of FIG. 4A includes digital media content (402) and a tag (106) identifying as potentially offensive a portion (108) of the digital media content (402).

In the digital media file of FIG. 4A, the potentially offensive portion (108) of the digital media content (402) is disposed at a location within the digital media file. Also in the digital media file, the tag (106) includes a header (214). The exemplary header in the digital media file (104) of FIG. 4A includes a pointer (404) to the location of the potentially offensive portion (108) of the digital media content (402) within the digital media file (104). With the pointer in the header a playback device always knows the location of potentially offensive material within a digital media file.

The digital media file of FIG. 4B is similar to the digital media file of FIG. 4A in that the digital media file of FIG. 4B also includes digital media content (402) and a tag (106) identifying as potentially offensive a portion (108) of the digital media content (402). The digital media file of FIG. 4B differs from the digital media file of FIG. 4A, however, in that in the digital media file of FIG. 4B the tag (106) includes a header (214) and a footer (224), the header (214) located before the potentially offensive portion (108) of the digital media content (104), the footer (224) located after the potentially offensive portion (108) of the digital media content (104). The header (214) in FIG. 4B may be a digital code identifying the beginning of the potentially offensive portion (108) of the digital media content (402). Likewise, the footer (224) may be a digital code identifying the end of the potentially offensive portion (108) of the digital media content (402). With the header in the digital media file marking the location of the potentially offensive portion of the digital media content, a playback device may always find the beginning potentially offensive portion of the digital media content in the digital media file by scanning the file for the header, the digital code. In similar manner the playback device may always find the end of the potentially offensive portion of the digital media content in the digital media file by scanning the file for the footer. Readers will recognize that by use of a pointer like the one in the example of FIG. 10A and header and footers similar to those in the example of FIG. 10B, the potentially offensive portion of the digital media content can be located almost anywhere in the digital media file, including, for example:
Potentially offensive portion located at the end of the digital media file, with the portion's location specified in a pointer in the header or with a single digital code at the beginning of the portion,
Potentially offensive portion located at an arbitrary point anywhere in the digital media content, with the portion location specified by a pointer and size field in the header, or with the portion location specified by a beginning and ending codes, a header and footer, inserted in the digital content respectively at the beginning and the end of the portion, and
Potentially offensive portion located entirely in the header, the portion location specified with beginning and ending codes, and no location pointer.

The tags (106) of the digital media files (104) of FIG. 4A and FIG. 4B also include an identification (216) of a type of potentially offensive material, an identification (220) of a severity of potentially offensive material, and a replacement (222) portion for replacing the potentially offensive material. The locations of these attributes and the replacement portions may be specified in manners similar to the location of the potentially offensive portion of digital media content in the digital media file. That is, the locations may be specified by a pointer in the header or a digital code identifying the locations of the attributes and replacement portions. Additionally, the replacement portions may not be included in the digital media file but may be located remotely with respect to the digital media file. In such cases, the header of the digital media file may include an identification of the location such as a URL. Although each of the attributes and replacement portions are depicted in the exemplary digital media files as excluded from the header, readers of skill in the art in the will recognize that such attributes and replacement portions may also be implemented as part of the header.

Exemplary embodiments of the present invention are described largely in the context of a fully functional computer system for administering a digital media file having one or more potentially offensive portions. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of administering a digital media file having one or more potentially offensive portions, the method comprising:
inserting in the digital media file at least one tag identifying as potentially offensive a portion of the digital media file, the tag also identifying a location of the potentially offensive portion in the digital media file; and
transmitting the digital media file with the tag to a playback device.

2. The method of claim 1 wherein inserting in the digital media file at least one tag identifying as potentially offensive a portion of the digital media file further comprises inserting as part of the tag an identification of a type of potentially offensive material.

3. The method of claim 1 wherein inserting in the digital media file at least one tag identifying as potentially offensive a portion of the digital media file further comprises inserting as part of the tag an identification of severity of potentially offensive material.

4. The method of claim 1 wherein inserting in the digital media file at least one tag identifying as potentially offensive a portion of the digital media file further comprises inserting as part of the tag one or more replacement portions for replacing the potentially offensive portion of the digital media file upon playback of the digital media file.

5. The method of claim 1 wherein inserting in the digital media file at least one tag identifying as potentially offensive a portion of the digital media file further comprises inserting as part of the tag a header and a footer, the header inserted before the potentially offensive portion of the digital media file, the footer inserted after the potentially offensive portion of the digital media file.

6. The method of claim 1 further comprising:
receiving, in the playback device, the digital media file with the tag;
identifying an action to take in dependence upon the tag and one or more potentially offensive material settings; and
playing the digital media file including taking the identified action.

7. The method of claim 6 wherein playing the digital media file including taking the identified action further comprises not playing the potentially offensive portion of the digital media file identified by the tag.

8. The method of claim 6 wherein playing the digital media file including taking the identified action further comprises playing a replacement portion of the digital media file included in the tag in place of the potentially offensive portion of the digital media file.

9. An apparatus for administering a digital media file having one or more potentially offensive portions, the apparatus comprising a computer processor, a computer memory operatively coupled to the computer processor, the computer memory having disposed within it computer program instructions capable of:
inserting in the digital media file at least one tag identifying as potentially offensive a portion of the digital media file, the tag also identifying a location of the potentially offensive portion in the digital media file; and
transmitting the digital media file with the tag to a playback device.

10. The apparatus of claim 9 wherein inserting in the digital media file at least one tag identifying as potentially offensive a portion of the digital media file further comprises inserting as part of the tag an identification of a type of potentially offensive material.

11. The apparatus of claim 9 wherein inserting in the digital media file at least one tag identifying as potentially offensive a portion of the digital media file further comprises inserting as part of the tag an identification of severity of potentially offensive material.

12. The apparatus of claim 9 wherein inserting in the digital media file at least one tag identifying as potentially offensive a portion of the digital media file further comprises inserting as part of the tag one or more replacement portions for replacing the potentially offensive portion of the digital media file upon playback of the digital media file.

13. The apparatus of claim 9 wherein inserting in the digital media file at least one tag identifying as potentially offensive a portion of the digital media file further comprises inserting as part of the tag a header and a footer, the header inserted before the potentially offensive portion of the digital media file, the footer inserted after the potentially offensive portion of the digital media file.

14. A computer program product for administering a digital media file having one or more potentially offensive portions, the computer program product disposed in a computer readable medium, the computer program product comprising computer program instructions capable of:
inserting in the digital media file at least one tag identifying as potentially offensive a portion of the digital media file, the tag also identifying a location of the potentially offensive portion in the digital media file; and
transmitting the digital media file with the tag to a playback device.

15. The computer program product of claim 14 wherein inserting in the digital media file at least one tag identifying as potentially offensive a portion of the digital media file further comprises inserting as part of the tag an identification of a type of potentially offensive material.

16. The computer program product of claim 14 wherein inserting in the digital media file at least one tag identifying as potentially offensive a portion of the digital media file further comprises inserting as part of the tag an identification of severity of potentially offensive material.

17. The computer program product of claim 14 wherein inserting in the digital media file at least one tag identifying as potentially offensive a portion of the digital media file further comprises inserting as part of the tag one or more replacement portions for replacing the potentially offensive portion of the digital media file upon playback of the digital media file.

18. The computer program product of claim 14 wherein inserting in the digital media file at least one tag identifying as potentially offensive a portion of the digital media file further comprises inserting as part of the tag a header and a footer, the header inserted before the potentially offensive portion of the digital media file, the footer inserted after the potentially offensive portion of the digital media file.

19. A digital media file comprising:
digital media content; and
a tag identifying as potentially offensive a portion of the digital media content.

20. The digital media file of claim 19 wherein:
the potentially offensive portion of the digital media content is disposed at a location within the digital media file; and
the tag further comprises a header, the header including a pointer to the location of the potentially offensive portion of the digital media content within the digital media file.

21. The digital media file of claim 19 wherein:
the potentially offensive portion of the digital media content is disposed at a location within the digital media file; and
the tag further comprises a header and a footer, the header located before the potentially offensive portion of the digital media content, the footer located after the potentially offensive portion of the digital media content.
